(19) United States
(12) Patent Application Publication
(10) Pub. No.: US 2025/0365254 A1
(43) Pub. Date: Nov. 27, 2025

(54) SWITCHING SYSTEM AND SWITCHING METHOD FOR MULTIPLE TRAIN SUPERVISION SYSTEMS

(71) Applicant: CASCO SIGNAL LTD., Shanghai (CN)

(72) Inventors: Gongjian ZHOU, Shanghai (CN); Ling LIU, Shanghai (CN); Jianquan LI, Shanghai (CN); Tingliang ZHOU, Shanghai (CN); Jiang QIAN, Shanghai (CN); Ying ZHAO, Shanghai (CN); Xue OUYANG, Shanghai (CN)

(21) Appl. No.: 18/876,616

(22) PCT Filed: Nov. 9, 2022
(86) PCT No.: PCT/CN2022/130872

§ 371 Date: Dec. 18, 2024

(30) Foreign Application Priority Data
Aug. 18, 2022 (CN) 202210994471.3

(51) Int. Cl. H04L 49/113; B61L 27/04; B61L 27/70; H04L 49/111; H04L 49/112

(52) U.S. Cl. CPC H04L 49/113; B61L 27/04; B61L 27/70; H04L 49/111; H04L 49/112

(57) ABSTRACT

A switching system and a switching method for a plurality of automatic train supervisions, in which the switching system is installed at each station, a redundant switching unit in the switching system includes a first signal communication interface machine and second signal communication interface machine, and a redundant switching module is connected to the first signal communication interface machine and second signal communication interface machine, respectively, and the first signal communication interface machine and second signal communication interface machine are connected to a new automatic train supervision and an existing automatic train supervision, respectively. A current signal communication interface machine in the redundant switching unit of the switching system switches from the existing automatic train supervision to the new automatic train supervision or from the new automatic train supervision to the existing automatic train supervision according to a switching instruction sent by a control center.

### CROSS-REFERENCE TO RELATED APPLICATIONS

This application is a National Stage of International Application No. PCT/CN2022/130872 filed on Nov. 9, 2022, which claims priority to Chinese Patent Application No. 202210994471.3 filed on Aug. 18, 2022, 2022. Both of the aforementioned applications are hereby incorporated by reference in their entireties.

### TECHNICAL FIELD

The present disclosure relates to a switching system and a switching method for a plurality of automatic train supervisions.

### BACKGROUND

A automatic train supervision is a brain of a rail transit signal system, a life cycle of the rail transit signal system is generally 20 years, after 20 years of life cycle maintenance, due to the development of technology and problems with the supply of existing compatible hardware, an existing automatic train supervision needs to be transformed before the life cycle arrives, ensuring long-term operations in the future by introducing a new automatic train supervision. However, during a transformation period, on the one hand, the existing automatic train supervision needs to continue to operate, on the other hand, the new automatic train supervision has not been fully verified. Once switched, an existing passenger service may be affected.

The statements herein only provide background art related to the present disclosure and do not necessarily constitute prior art.

### SUMMARY OF THE DISCLOSURE

An objective of the present disclosure is to provide the switching system and the switching method for the plurality of automatic train supervisions, ensuring a reliable switching between the new system and the existing system, reducing switching time and switching workload.

In order to achieve the above objective, the present disclosure provides the switching system for the plurality of automatic train supervisions, the switching system is installed at each station and the switching system includes:
a hot backup and cold backup switching module including a first transfer switch and a second transfer switch, and the transfer switches all being single-pole double-throw switches; a fixed end of the first transfer switch connected to a wayside interlocking system through a serial port, a free end of the first transfer switch connected to a cold backup simplified automatic train supervision through the serial port, another free end of the first transfer switch connected to a redundant switching unit through the serial port; and a fixed end of the second transfer switch connected to a wayside train control system through the serial port, a free end of the second transfer switch connected to the cold backup simplified automatic train supervision through the serial port, and another free end of the second transfer switch connected to the redundant switching unit through the serial port;
the redundant switching unit including a first signal communication interface machine connected to the new automatic train supervision and the existing automatic train supervision and a second signal communication interface machine connected to the new automatic train supervision and the existing automatic train supervision, the first signal communication interface machine and the second signal communication interface machine being redundantly installed, either of the first signal communication interface machine and the second signal communication interface machine serving as a main machine being considered as a current signal communication interface machine, the redundantly installed first signal communication interface machine and second signal communication interface machine being a main machine and a backup machine for each other, thereby ensuring system reliability and preventing systematic random failures; and a redundant switching module connected to the first signal communication interface machine and the second signal communication interface machine, to achieve a switching identity of the first signal communication interface machine and second signal communication interface machine serving as the main machine or the backup machine.

The hot backup and cold backup switching module adopts a mechanical serial port switching board.

The first signal communication interface machine and the second signal communication interface machine are CPUs loaded with control software.

The redundant switching module includes an electronic switch for switching between the first signal communication interface machine and the second signal communication interface machine to serve as the main machine or the backup machine.

The redundant switching module includes a monitoring module, the monitoring module is configured to monitor states of the first signal communication interface machine and the second signal communication interface machine, and to determine whether to switch a state where the first signal communication interface machine and the second signal communication interface machine is in the main machine or the backup machine.

The monitoring module adopts a hardware timer circuit or a software timer circuit.

The present disclosure also provides a switching method for the plurality of automatic train supervisions including: sending, by a control center, a pre-switching instruction to a current signal communication interface machine in a redundant switching unit in a switching system of all stations through a new automatic train supervision remotely; sending, by the control center, a formal switching instruction to the current signal communication interface machine in the redundant switching unit in the switching system of all stations through the new automatic train supervision after the current signal communication interface machine in the redundant switching unit in the switching system of all stations receives the pre-switching instruction; and switching the current signal communication interface machine in the redundant switching unit in the switching system from the existing automatic train supervision to the new automatic train supervision, or from the new automatic train supervision to the existing automatic train supervision based on the formal switching instruction.

After receiving the pre-switching instruction, the current signal communication interface machine sends a reply message of successful reception to the control center.

The control center continues the sending of the formal switching instruction when receiving the reply message of successful reception sent by the switching system of all stations within a first preset time after the sending of the pre-switching instruction.

After receiving the formal switching instruction, the current signal communication interface machine in the redundant switching unit in the switching system of each station executes the formal switching instruction, and sends a reply message of successful switching to the control center after a switching is successful.

The control center receives the reply message of successful switching sent by the switching system of all stations within the second preset time, indicating that a full line switching is successful, and the second preset time is greater than the first preset time.

The control center does not receive the reply message of successful reception sent by the switching system of all stations within the first preset time, or does not receive the reply message of successful switching sent by the switching system of all stations within the second preset time, indicating that a remote switching fails.

After the remote switching fails, the control center contacts a staff member on site at a station to perform a local switching, to switch the first transfer switch and the second transfer switch to the cold backup automatic train supervision of the station by manually operating the hot backup and cold backup switching module in the redundant switching unit.

After a mutual switching between the new automatic train supervision and the existing automatic train supervision is restored to normal, the control center contacts the staff member on site at the station to switch the first transfer switch and the second transfer switch to the redundant switching unit by manually operating the hot backup and cold backup switching module in the redundant switching unit, and then to achieve the mutual switching between the new automatic train supervision and the existing automatic train supervision by the redundant switching unit subsequently.

The signal communication interface machine in the redundant switching unit performs data replication to achieve data synchronization between the new automatic train supervision and the existing automatic train supervision.

The redundant switching unit forwards interlocking data and train control data obtained from the current signal communication interface machine to the new automatic train supervision when in an operating mode of the new automatic train supervision, while replicating and transmitting the interlocking data to the existing automatic train supervision through an interlocking information serial port replication program in the current signal communication interface machine, and replicating and transmitting the train control data to the existing automatic train supervision through a train control information serial port replication program; and the redundant switching unit forwards the interlocking data and the train control data obtained from the current signal communication interface machine to the existing automatic train supervision when in an operating mode of the existing automatic train supervision, while replicating and transmitting the interlocking data to the new automatic train supervision through the interlocking information serial port replication program in the current signal communication interface machine, and replicating and transmitting the train control data to the new automatic train supervision through the train control information serial port replication program.

The redundantly installed first signal communication interface machine and second signal communication interface machine periodically access the monitoring module in the redundant switching module during an operation of the switching system at each station, if the current signal communication interface machine serving as the main machine fails to periodically access the monitoring module within a predetermined time, the monitoring module determines that an operating state of the current signal communication interface machine is unstable, disqualifies the current signal communication interface machine serving as the main machine, downgrades the current signal communication interface machine to the backup machine, and switches the signal communication interface machine previously used as the backup machine to the main machine.

The present disclosure has the following beneficial effects:
1. By dynamically adjusting a data flow, a remote one-time full line switching can be achieved, which saves a lot of time required for manual operation in the station compared with manual work.
2. By dynamically adjusting the data flow, on the one hand, a normal operation of the existing automatic train supervision is ensured, and at the same time, a replication of serial port data is completed to support an online debugging of the new automatic train supervision, which greatly alleviates a problem of limited debugging time in a transformation project.
3. By adopting a delayed execution of the instruction, a one-time interaction of the control center in the execution of the remote switching is ensured, which reduces a workload on the one hand, and ensures the reliability of the instruction through a program logic on the other hand.
4. A simple serial port reconnection circuit is adopted to ensure a reliable switching between a hot backup system and a cold backup system, thereby providing a plan of a cold backup emergency operation for the new automatic train supervision and the existing automatic train supervision after a failure.
5. A dual-machine redundant unit is adopted to improve the reliability of interface communication software, once a machine fails, the backup machine will be upgraded to the main machine, and the original main machine will be downgraded to the backup machine, ensuring a reliable operation of an entire system.

### BRIEF DESCRIPTION OF DRAWINGS

FIG. 1 is a schematic diagram of the switching system for the plurality of automatic train supervisions provided by the present disclosure.

FIG. 2 is a schematic diagram of data replication in the switching method for the plurality of automatic train supervisions provided by the present disclosure.

### DETAILED DESCRIPTION

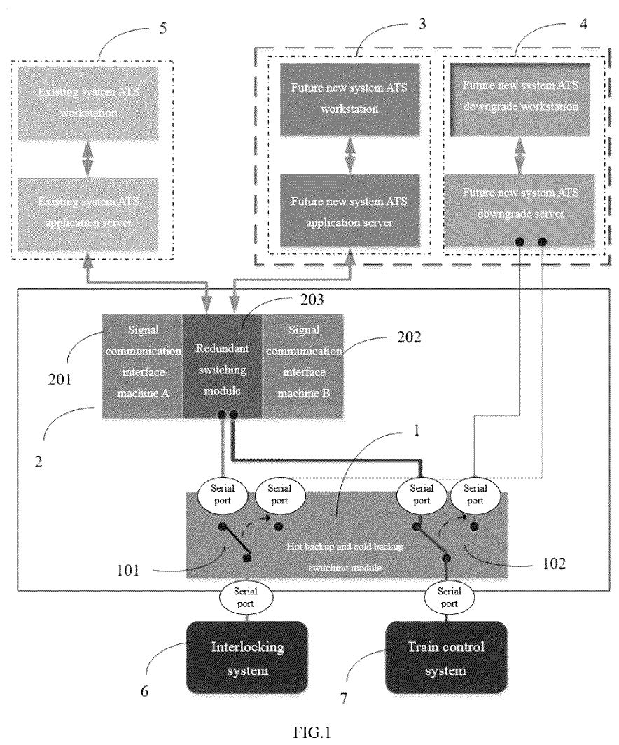

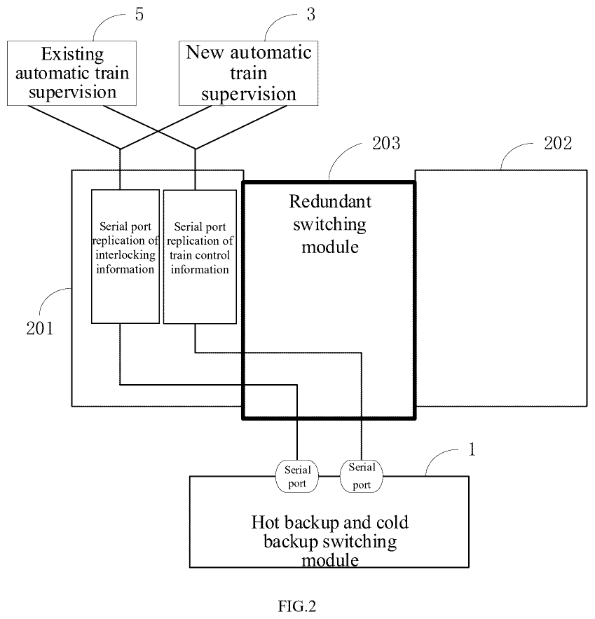

A preferred embodiment of the present disclosure is hereinafter specified according to FIGS. 1 to 2.

Both the existing automatic train supervision and the new automatic train supervision are installed in the control center, in a process of switching between the existing automatic train supervision and the new automatic train supervision, in order to ensure that the staff member can manually ensure the normal operation in the first place, it is also necessary to install the cold backup automatic train supervision at each station to prevent a switching failure between the new system and the existing system. The existing automatic train supervision, the new automatic train supervision and the cold backup automatic train supervision all include a server and a workstation.

As shown in FIG. 1, the present disclosure provides the switching system for the plurality of automatic train supervisions, the switching system is provided at each station, the switching system includes:
the hot backup and cold backup switching module 1, which includes the first transfer switch and the second transfer switch, and the transfer switches all being single-pole double-throw switches; the fixed end of the first transfer switch 101 connected to the interlocking system 6 through the serial port, the free end of the first transfer switch 101 connected to the cold backup simplified automatic train supervision 4 through the serial port, another free end connected to the redundant switching unit 2 through the serial port; the fixed end of the second transfer switch 102 connected to the train control system 7 through the serial port, the free end of the second transfer switch 102 connected to the cold backup simplified automatic train supervision 4 through the serial port, and another free end connected to the redundant switching unit 2 through the serial port;
the redundant switching unit 2, which includes the redundantly installed first signal communication interface machine and second signal communication interface machine, and the redundant switching module 203 connected to the first signal communication interface machine and second signal communication interface machine respectively; the first signal communication interface machine 201 connected to the new automatic train supervision 3 and the existing automatic train supervision 4 respectively, the second signal communication interface machine 202 also connected to the new automatic train supervision 3 and the existing automatic train supervision 4 respectively, the switching module 203 connected to the first transfer switch 101 and the second transfer switch 102 in the hot backup and cold backup switching module 1 respectively; the redundant switching module 203 achieving the switching between the first signal communication interface machine and second signal communication interface machine, the redundantly installed first signal communication interface machine 201 and the second signal communication interface machine 202 being the main machine and the backup machine for each other, thereby ensuring system reliability and preventing systematic random failures.

In the present embodiment, the hot backup and cold backup switching module 1 adopts the mechanical serial port switching board, and a pure circuit design ensures reliability of a degraded mode operation. The first signal communication interface machine 201 and the second signal communication interface machine 202 are CPUs loaded with the control software; the redundant switching module 203 includes the electronic switch for switching the first signal communication interface machine and second signal communication interface machine serving as the main machine or backup machine; the redundant switching module 203 also includes the monitoring module, the monitoring module is used to monitor the states of the first signal communication interface machine 201 and the second signal communication interface machine 202, and to determine whether to switch the state of the main machine and the backup machine of the first signal communication interface machine and second signal communication interface machine, the monitoring module can adopt the hardware timer circuit or the software timer circuit.

The present disclosure also provides the switching method for the plurality of automatic train supervisions, including the following operations.

Assemble the switching system of each station, the hot backup and cold backup switching module 1 and the redundant switching unit 2 are connected through internal serial port wiring, only one set of serial port connectors with the interlocking system 6 and the train control system 7 are exposed to the outside, the switching system is connected to the wayside interlocking system and the train control system respectively through the serial port connectors.

Power on the machines, start the software in the switching system, initialize a main thread, initialize system parameters, open a serial port resource in a hardware module (as shown in FIG. 1), establish signal communication between the interlocking system and train control system, the redundant switching unit 2 establishes a connection with the new automatic train supervision and interacts with the operating state of the current signal communication interface machine.

The control center sends the switching instruction to the switching system of all stations by the new automatic train supervision, so that the data flow of all stations on the full line is synchronized to switch from the existing automatic train supervision to the new automatic train supervision, or from the new automatic train supervision to the existing automatic train supervision;
take the switching from the existing automatic train supervision to the new automatic train supervision as an example to illustrate a full process of switching: the control center remotely sends the pre-switching instruction (the instruction to switch to the new automatic train supervision) to the current signal communication interface machine (the first signal communication interface machine 201 or the second signal communication interface machine 202) in the redundant switching unit 2 in the switching system of all stations through the workstation of the new automatic train supervision; after receiving the pre-switching instruction, the current signal communication interface machine in the redundant switching unit 2 in the switching system of each station sends the reply message of successful reception to the control center. The control center checks the reply message of successful reception sent by the switching system of all stations within the first preset time (e.g. 10 s). If all stations confirm the reply message of successful reception, the formal switching instruction will be automatically sent; after receiving the formal switching instruction, the current signal communication interface machine in the redundant switching unit 2 in the switching system of each station sends the reply message of successful reception to the control center, at the same time executes the formal switching instruction, switches from the existing automatic train supervision of the station to the new automatic train supervision, interactively adjust interface information of the station, the interlocking system, the wayside train control system and an on-board train control system to the new automatic train supervision, and send the reply message of successful switching to the control center after the switching is successful;
it indicates that all stations have switched to the new automatic train supervision after receiving the reply message of successful switching sent by the switching system of all stations within the second preset time (30 s), prompting the successful switching of the full line; if the control center does not receive the reply message of successful reception from some stations within the first preset time, the switching will be stopped and an alarm will be generated, prompting that there is a communication problem at some stations and that a full line switching instruction cannot be executed; if the reply message of successful switching sent by all stations is not received within the second preset time, the control system generates an alarm, prompting that some stations have failed to switch. In the process of switching, a dispatcher of the control center should ensure that online trains temporarily stop at each station and wait for the system to complete the switching.

The control center sends the instruction to numerous switching units in the station, and considering the complexity of the process of switching, two instructions of pre-switching and formal switching are designed. Sending the pre-switching instruction first is equivalent to path exploration, and once it is found that there is a communication problem at a station, the switching will not be performed temporarily and a user will first solve the communication problem. Once the communication problem is solved, the formal switching instruction is then sent, because the formal switching instruction can be executed more reliably on the basis of normal communication, increasing the probability of one-time successful execution. After a first-time success, a design is automatically executed in a background for a second time, also simplifying the user's operation operations. After a first-time failure, the user will continue to use an original system without switching, thereby minimizing an impact of the switching on the user.

If the mutual switching between the new automatic train supervision and the existing automatic train supervision fails, the control center contacts the staff member on site at the station to perform the local switching, that is, to switch the first transfer switch and the second transfer switch to the station's cold backup automatic train supervision by manually operating the hot backup and cold backup switching module 1 in the redundant switching unit 2, thereby interactively adjusting the interface information of the station, the interlocking system, the wayside train control system and the on-board train control system to the cold backup automatic train supervision, and the cold backup automatic train supervision is used to maintain a continuous operation of an existing line. After the mutual switching between the new automatic train supervision and existing automatic train supervision is restored to normal, the control center contacts the staff member on site at the station to switch the first transfer switch and the second transfer switch to the redundant switching unit 2 by manually operating the hot backup and cold backup switching module 1 in the redundant switching unit 2, and then to achieve the mutual switching between the new automatic train supervision and the existing automatic train supervision by the redundant switching unit 2 subsequently.

The signal communication interface machine in the redundant switching unit 2 performs the data replication to achieve data synchronization between the new automatic train supervision and existing automatic train supervision. As shown in FIG. 2, the redundant switching unit 2 forwards interlocking data and train control data obtained from the first signal communication interface machine 201 or the second signal communication interface machine 202 to the new automatic train supervision when in an operating mode of the new automatic train supervision, while replicating and transmitting the interlocking data to the existing automatic train supervision through an interlocking information serial port replication program in the first signal communication interface machine 201 or the second signal communication interface machine 202, and replicating and transmitting the train control data to the existing automatic train supervision through a train control information serial port replication program; similarly, the redundant switching unit 2 forwards the interlocking data and the train control data obtained from the first signal communication interface machine 201 or the second signal communication interface machine 202 to the existing automatic train supervision when in an operating mode of the existing automatic train supervision, while replicating and transmitting the interlocking data to the new automatic train supervision through the interlocking information serial port replication program, and replicating and transmitting the train control data to the new automatic train supervision through the train control information serial port replication program. Through information replication, it is ensured that a automatic train supervision without a control right can also obtain a current state of the interlocking system and train control system.

During the operation of the switching system at each station, the redundantly installed first signal communication interface machine and second signal communication interface machine are adopted to ensure reliable communication. Take the first signal communication interface machine 201 serving as the main machine and the second signal communication interface machine 202 serving as the backup machine as an example. Both the first signal communication interface machine 201 and the second signal communication interface machine 202 periodically access the monitoring module in the redundant switching module 203 according to a specified time interval (e.g., 500 ms), the monitoring module may be a hardware watchdog circuit, and the watchdog circuit monitors a state of the first signal communication interface machine 201 and the second signal communication interface machine 202 in real time. If the first signal communication interface machine 201 currently serving as the main machine fails to access the watchdog circuit periodically within a predetermined time (e.g., 1.5 s, i.e., three cycles), the watchdog circuit determines that an operating state of the first signal communication interface machine 201 is unstable, disqualifies the first signal communication interface machine 201 serving as the main machine, downgrades the first signal communication interface machine 201 to the backup machine, and switches the second signal communication interface machine 202 to the main machine.

A control mode of each station is displayed in real time on the new automatic train supervision in the control center; if a current control is under a control mode of the new automatic train supervision, a current control mode of the station is displayed as Normal mode, and the staff member of the control center uses the new automatic train supervision transformed by the control center to test each function in Normal mode; if the current control is under a control mode of the existing automatic train supervision, the current control mode of the station is displayed as Backup mode, and the staff member of the control center uses the existing automatic train supervision of the control center to test each function in Backup mode; if the current control is under a control mode of the cold backup automatic train supervision, the current control mode of the station is displayed as Critical mode. The default operating mode of the switching system of the present disclosure is Normal mode, that is, the control mode of the new automatic train supervision.

The present disclosure achieves an effective switching between three automatic train supervisions from a start of transformation work of the existing automatic train supervision, to a trial operation period of the new automatic train supervision, and then to the completion of transformation and switching to the new automatic train supervision. During the transformation period of the existing signal system, after the transformation is started and the new system is not online yet, the existing system is maintained. However, the new system is debugged at night, and the switching between the new system and the existing system of the present disclosure is adopted. After the debugging of the new system is completed, the switching from the new system to the existing system of the present disclosure is adopted to prevent a problem in the new system during a period that the new system is put into a main line trial operation. After the new system goes online, the cold backup system will always be retained to prevent the new system and old system from failing at the same time, and a final means of manual protection is retained.

The present disclosure has the following beneficial effects:
1. By dynamically adjusting a data flow, a remote one-time full line switching can be achieved, which saves a lot of time required for manual operation in the station compared with manual work.
2. By dynamically adjusting the data flow, on the one hand, a normal operation of the existing automatic train supervision is ensured, and at the same time, a replication of serial port data is completed to support an online debugging of the new automatic train supervision, which greatly alleviates a problem of limited debugging time in a transformation project.
3. By adopting a delayed execution of the instruction, a one-time interaction of the control center in the execution of the remote switching is ensured, which reduces a workload on the one hand, and ensures the reliability of the instruction through a program logic on the other hand.
4. A simple serial port reconnection circuit is adopted to ensure a reliable switching between a hot backup system and a cold backup system, thereby providing a plan of a cold backup emergency operation for the new automatic train supervision and the existing automatic train supervision after a failure.
5. A dual-machine redundant unit is adopted to improve the reliability of interface communication software, once a machine fails, the backup machine will be upgraded to the main machine, and the original main machine will be downgraded to the backup machine, ensuring a reliable operation of an entire system.

It should be noted that in the embodiment of the present disclosure, terms “center”, “longitudinal”, “lateral”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, “circumferential” and the like are an orientation or positional relationship shown in the figures. The terms are only for the convenience of describing the embodiment and do not indicate or imply that the device or element referred to must have a specific orientation, constructed and operated in the specific orientation, and therefore are not to be construed as limitations of the present disclosure. In addition, the terms “first”, “second”, and “third” are used for a descriptive purpose only and should not be construed as indicating or implying a relative importance.

In the present disclosure, unless otherwise clearly specified and limited, the terms “installation”, “link”, “connection”, “fixation” and the like should be construed in a broad sense. For example, “connection” can be a fixed connection, a detachable connection, or an integrated connection, a mechanical connection or an electrical connection, a direct connection or an indirect connection through an intermediate medium, and an internal connection between two elements or an interaction between the two elements. To a normal person skilled in the art, specific meanings of terms above in the present disclosure can be understood based on specific situations.

Although the content of the present disclosure has been described in detail by the preferred embodiment above, it should be recognized that the above description should not be considered a limitation on the present disclosure. Various modifications and alternatives to the present disclosure will become apparent to those skilled in the art upon reading the foregoing disclosure. Accordingly, the protection scope of the present disclosure shall be limited by the appended claims.

1. A switching system for a plurality of automatic train supervisions, installed at each station, comprising:
a redundant switching unit comprising:
a first signal communication interface machine connected to a new automatic train supervision and an existing automatic train supervision, and
a second signal communication interface machine connected to the new automatic train supervision and the existing automatic train supervision, the first signal communication interface machine and the second signal communication interface machine being redundantly installed, either of the first signal communication interface machine and the second signal communication interface machine serving as a main machine being considered as a current signal communication interface machine, the first signal communication interface machine and second signal communication interface machine being the main machine and a backup machine for each other, thereby ensuring a reliability of the switching system and preventing systematic random failures; and
a redundant switching module connected to the first signal communication interface machine and the second signal communication interface machine, to achieve a switching of the first signal communication interface machine and the second signal communication interface machine serving as the main machine or the backup machine.

2. The switching system according to claim 1, further comprising:
a hot backup and cold backup switching module, comprising:
a first transfer switch and a second transfer switch, the first transfer switch and the second transfer switch being single-pole double-throw switches; a fixed end of the first transfer switch connected to a wayside interlocking system through a serial port, a free end of the first transfer switch connected to a cold backup simplified automatic train supervision through the serial port, another free end of the first transfer switch connected to the redundant switching module through the serial port; and a fixed end of the second transfer switch connected to a wayside train control system through the serial port, a free end of the second transfer switch connected to the cold backup simplified automatic train supervision through the serial port, and another free end of the second transfer switch connected to the redundant switching module through the serial port.

3. The switching system according to claim 2, wherein the hot backup and cold backup switching module adopts a mechanical serial port switching board.

4. The switching system according to claim 3, wherein the first signal communication interface machine and the second signal communication interface machine are central processing units (CPUs) loaded with control software.

5. The switching system according to claim 4, wherein the redundant switching module comprises an electronic switch for switching between the first signal communication interface machine and the second signal communication interface machine to serve as the main machine or the backup machine.

6. The switching system according to claim 5, wherein the redundant switching module comprises a monitoring module configured to monitor states of the first signal communication interface machine and the second signal communication interface machine, and to determine whether to switch a state where the first signal communication interface machine and the second signal communication interface machine is serving as the main machine or the backup machine.

7. The switching system according to claim 6, wherein the monitoring module adopts a hardware timer circuit or a software timer circuit.

8. A switching method of a plurality of automatic train supervisions, comprising:
sending, by a processor of a control center, a pre-switching instruction to a current signal communication interface machine in a redundant switching unit in a switching system of all stations through a new automatic train supervision remotely, wherein the plurality of automatic train supervisions include the new automatic train supervision and an existing automatic train supervision;
sending, by the processor of the control center, a formal switching instruction to the current signal communication interface machine through the new automatic train supervision after the current signal communication interface machine receives the pre-switching instruction;
switching, by the processor of the control center the current signal communication interface machine from the existing automatic train supervision to the new automatic train supervision, or from the new automatic train supervision to the existing automatic train supervision based on the formal switching instruction; and
operating trains according to the new automatic train supervision or the existing automatic train supervision based on the switching.

9. The switching method according to claim 8, wherein after receiving the pre-switching instruction, the current signal communication interface machine sends a reply message indicating a successful reception to the control center.

10. The switching method according to claim 9, wherein the sending, by the processor of the control center, the formal switching instruction comprises:
sending, by the processor of the control center, the formal switching instruction when receiving the reply message indicating the successful reception within a first preset time after the sending the pre-switching instruction.

11. The switching method according to claim 10, wherein after receiving the formal switching instruction, the current signal communication interface machine executes the formal switching instruction, and sends a second reply message indicating a switching being successful to the control center after the switching is successful.

12. The switching method according to claim 11, further comprising:
receiving, by es the control center, the second reply message within a second preset time, indicating that a switching being a full line switching is successful, and the second preset time is greater than the first preset time.

13. The switching method according to claim 8, further comprising:
determining, by the processor of the control center, a remote switching fails, in response to not receiving a reply message indicating a successful reception sent by the switching system of all stations within a first preset time, or not receiving a second reply message indicating a switching being successful sent by the switching system of all stations within a second preset time.

14. The switching method according to claim 13, further comprising:
in response to the determining the remote switching fails, switching, by a processor of a local switching, a first transfer switch and a second transfer switch to a cold backup automatic train supervision.

15. The switching method according to claim 14, further comprising:
after a mutual switching between the new automatic train supervision and the existing automatic train supervision is restored to normal, switching, by the processor of the local switching, the first transfer switch and the second transfer switch to a redundant switching unit; and
achieving the mutual switching between the new automatic train supervision and the existing automatic train supervision by the redundant switching unit subsequently.

16. The switching method according to claim 8, wherein the current signal communication interface machine in the redundant switching unit performs a data replication to achieve data synchronization between the new automatic train supervision and the existing automatic train supervision.

17. The switching method according to claim 16, further comprising:
forwarding, by the redundant switching unit, interlocking data and train control data obtained from the current signal communication interface machine to the new automatic train supervision when in an operating mode of the new automatic train supervision, while replicating and transmitting the interlocking data to the existing automatic train supervision through an interlocking information serial port replication program in the current signal communication interface machine, and replicating and transmitting the train control data to the existing automatic train supervision through a train control information serial port replication program; and
forwarding, by the redundant switching unit, the interlocking data and the train control data obtained from the current signal communication interface machine to the existing automatic train supervision when in an operating mode of the existing automatic train supervision, while replicating and transmitting the interlocking data to the new automatic train supervision through the interlocking information serial port replication program in the current signal communication interface machine, and replicating and transmitting the train control data to the new automatic train supervision through the train control information serial port replication program.

18. The switching method according to claim 8, wherein a first signal communication interface machine and a second signal communication interface machine periodically access a monitoring module in the redundant switching module during an operation of the switching system at each station, in response to the current signal communication interface machine serving as a main machine fails to periodically access the monitoring module within a predetermined time, the monitoring module determines that an operating state of the current signal communication interface machine is unstable, disqualifies the current signal communication interface machine serving as the main machine, downgrades the current signal communication interface machine to a backup machine, and switches a signal communication interface machine previously used as the backup machine to the main machine.

19. The switching method according to claim 17, wherein a first signal communication interface machine and a second signal communication interface machine periodically access a monitoring module in the redundant switching module during an operation of the switching system at each station, in response to the current signal communication interface machine serving as a main machine fails to periodically access the monitoring module within a predetermined time, the monitoring module determines that an operating state of the current signal communication interface machine is unstable, disqualifies the current signal communication interface machine serving as the main machine, downgrades the current signal communication interface machine to a backup machine, and switches a signal communication interface machine previously used as the backup machine to the main machine.
